(19) United States
(12) Patent Application Publication
(10) Pub. No.: US 2016/0081501 A1
(43) Pub. Date: Mar. 24, 2016

(54) Drinking container having illuminated outlet

(71) Applicant: Gregory Maniatis, Christchurch (NZ)

(72) Inventor: Gregory Maniatis, Christchurch (NZ)

(21) Appl. No.: 14/493,342

(22) Filed: Sep. 22, 2014

(51) Int. Cl. A47G 19/22; F21V 23/04; F21V 33/00; B65D 85/72; F21K 2/00

(52) U.S. Cl. CPC A47G 19/2227; B65D 85/72; F21K 2/00; F21V 33/0036; F21V 23/0414; A47G 2200/08; F21Y 2101/02

(57) ABSTRACT

Disclosed is a drinking container having an illuminated outlet for facilitating the consumption of a beverage in poor lighting. The drinking container has a light source such as a phosphorescent ring proximate to the edges of the outlet, which allows the consumption of the beverage in low light conditions.

### FIELD OF THE INVENTION

The present invention relates generally to a drinking container having an illuminated outlet for facilitating the consumption of a beverage in poor lighting.

Particularly, but not exclusively, the invention relates to a drinking container having an illuminated outlet for facilitating the consumption of a beverage in poor lighting, said drinking container having a light source proximate to said outlet, such that a user is aware of the location of said outlet on said drinking container.

### BACKGROUND OF THE INVENTION

Beverages are often drunk from containers in low light conditions such as at nighttime, when driving, or when indoors. Often, it is not possible to quickly determine where the outlet of a drinking container is located. Where a container is a coffee cup with hot coffee, this can result in spillage and possible harm to a user, especially when a user is distracted, such as when driving. A user may also be in a room with poor lighting. In such situations, it may be possible that a user will not know where the aperture of their drinking container is located, which may cause spillage and possible damage to a person's clothing or the environment.

Accordingly, it is an object of the present invention to provide a means for assisting a consumer to easily locate the aperture of a drinking container.

It is a further object of the present invention to facilitate the consumption of a beverage in poor lighting.

Further objects and advantages of the present invention will be disclosed and become apparent from the following description. These objects are to be read disjunctively with the object of at least providing the public with a useful choice.

### SUMMARY OF THE INVENTION

The present invention relates generally to a drinking container having an illuminated outlet for facilitating the consumption of a beverage in poor lighting.

According to a first aspect of the invention, there is provided a drinking container comprising:

a container having at least one outlet;

a light source proximate to said outlet wherein said light source is arranged and configured such that a user can be made aware of the location of said outlet.

Preferably, said light source comprises a phosphorescent material.

Alternatively, said light source comprises a light emitting diode.

Alternatively, said light source comprises an adhesive layer comprising phosphorescent material.

Preferably, said light source has a shape and configuration substantially corresponding to the edges of said outlet.

Preferably, said light source comprises a band of phosphorescent material surrounding said outlet.

Preferably, said band is located within 2 centimetres of edge of said outlet.

Preferably, the light source permits illumination of the outlet for the minimum period of time required to consume the beverage.

Alternatively, said light source can be activated by a user using activation means and deactivated by a user using deactivation means.

Preferably, said drinking container contains an alcoholic or non-alcoholic beverage.

More specific features for preferred embodiments are set out in the description below.

### BRIEF DESCRIPTION OF THE DRAWINGS

The invention will now be described by way of example only with reference to the accompanying drawings, in which:

FIG. 1 shows a perspective view of a drinking container with a light source according to an embodiment of the invention.

FIG. 2 shows a top view of a drinking container lid with an annular light source according to an embodiment of the invention.

FIG. 3 shows a top view of a drinking container lid with a light source according to an alternative embodiment of the invention.

### DETAILED DESCRIPTION OF THE INVENTION

Various embodiments of the present invention are described hereinafter with reference to the figures. It should be noted that the figures are only intended to facilitate the description of specific embodiments of the invention. In addition, an aspect described in conjunction with a particular embodiment of the present invention is not necessarily limited to that embodiment and can be practiced in any other embodiments of the present invention.

The present invention relates generally to a drinking container having an illuminated outlet for facilitating the consumption of a beverage in poor lighting.

Particularly, but not exclusively, the invention relates to a drinking container having an illuminated outlet for facilitating the consumption of a beverage in poor lighting, said drinking container having a light source proximate to said outlet, such that a user is aware of the location of said outlet on said drinking container.

In accordance with a preferred embodiment the drinking container includes a light source proximate to the outlet, said light source comprising a phosphorescent material or a light emitting diode. Alternatively, said light source may comprise an adhesive layer comprising phosphorescent material. Preferably, said light source has a shape and configuration substantially corresponding to the edges of said outlet. Preferably, said phosphorescent material or a light emitting diode is capable of illuminating the outlet for the minimum period of time required for a user to consume the beverage in low light conditions, for example 1-2 hours. Preferably the said phosphorescent material is “charged” by placing it in a well-lit area prior to consumption by a user. Preferably the said light emitting diode has a battery or independent power source (such as a solar cell). Preferably, said light source is located within 2 centimetres of the outlet in order to help a user accurately locate the outlet and minimise the chance of spillage.

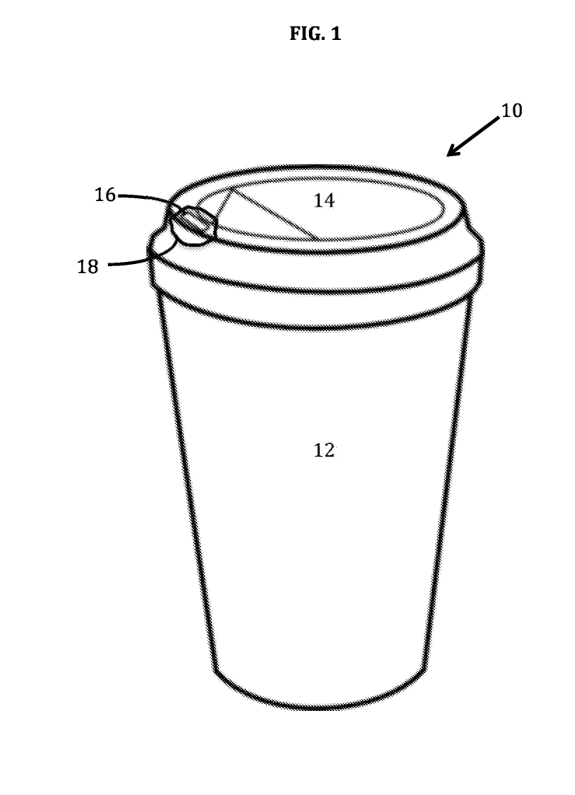

FIG. 1 shows a perspective view of a drinking container 10 with a light source according to an embodiment of the invention. In this particular embodiment, the drinking container 10 is a coffee cup comprising a base 12, and a lid 14, said lid having an outlet 16, and an annular band of phosphorescent material 18 surrounding said outlet.

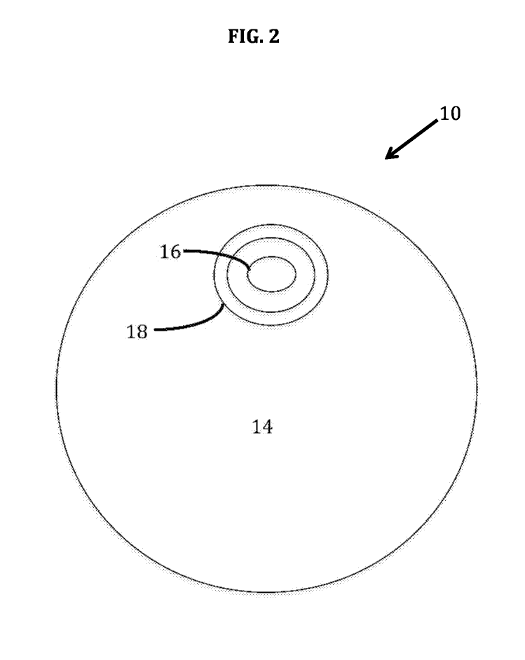

FIG. 2 shows a top view of a drinking container lid 14 with an annular light source according to an embodiment of the invention. In this particular embodiment, the light source comprises a band of phosphorescent material 18 surrounding said outlet 16. Preferably, said band is located within 2 centimetres of edge of said outlet.

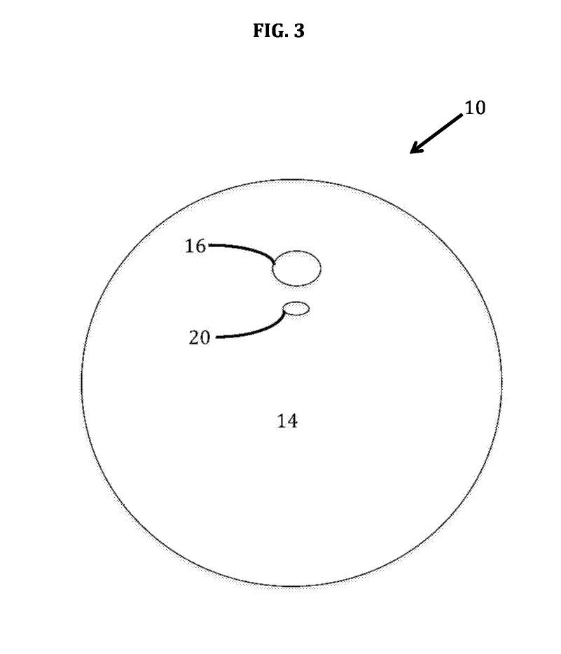

FIG. 3 shows a top view of a drinking container lid 14 with a light source according to an alternative embodiment of the invention. In this particular embodiment, the light source comprises a light emitting diode 20 surrounding said outlet 16. Preferably, said light emitting diode is located proximate to edge of said outlet.

Preferably, the drinking container may be made of hard paperboard or plastic. Where the drinking container is made of plastic, preferably, the light source comprises phosphorescent material which is of a different kind of plastic. Preferably, the phosphorescent plastic is incorporated into the container at the tine of manufacture using various techniques known to those skilled in the art, including injection moulding. Where the drinking container is made of paperboard or similar material, preferably the light source comprises a light emitting diode. Alternatively, the light source could be an adhesive phosphorescent layer attached proximate to the outlet of the container after it has been manufactured.

In use, the drinking container will be filled with a liquid suitable for consumption such as an alcoholic or non-alcoholic beverage. The drinking container may be filled on location or at a previous location. When consumed, a user will be able to locate the outlet using the light source. For example, where the drinking container is a coffee cup, and the light source is an annular band of phosphorescent material, a user will be able to easily locate the outlet even in low light conditions, such as when driving a vehicle at night. When the coffee cup is not in use, it can be placed in a coffee cup holder in the vehicle. When the light source is activated, a user can then easily find the coffee cup outlet and drink coffee in low light conditions.

It will be apparent to those skilled in the art that the drinking container may comprise many shapes suitable for containing a beverage with a relatively small outlet which may be difficult to locate, including but not limited to a bottle or flask.

There also may be various other means of providing light sources which are capable of being activated to emit light for a minimum period at a later time, such as a “glow stick” which is activated by mixing fluorescent chemicals together, which can illuminate the outlet at a time after the drinking container has been purchased. Similarly, in an alternative embodiment, the light emitting diode could be activated and deactivated using a button, and could be configured to retain charge from a solar cell until required. This has the effect of allowing a user to activate the light source at a later time when required to illuminate the outlet.

While the invention has been illustrated and described in detail in the foregoing description, such illustration and description are to be considered illustrative or exemplary and non-restrictive; the invention is thus not limited to the disclosed embodiments. Features mentioned in connection with one embodiment described herein may also be advantageous as features of another embodiment described herein without explicitly showing these features. Variations to the disclosed embodiments can be understood and effected by those skilled in the art and practicing the claimed invention, from a study of the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A drinking container comprising;
a container having at least one outlet
A light source proximate to said outlet wherein said light source is arranged and configured to provide illumination in an area substantially only proximate to said outlet such that a user is made aware of the location of said outlet when consuming a beverage in poor lighting.

2. The drinking container of claim 1, wherein said light source comprises a phosphorescent material.

3. The drinking container of claim 1 wherein said light source comprises a light emitting diode.

4. The drinking container of claim 1, wherein said light source comprise an adhesive layer comprising phosphorescent material.

5. The drinking container of claim 1, wherein said light source has a shape and configuration substantially corresponding to the edges of said outlet.

6. The drinking container of claim 1, wherein said light source comprises a band of phosphorescent material surrounding said outlet.

7. The drinking container of claim 6, wherein said band is located within 2 cm of edge of said outlet.

8. The drinking container of claim 1, wherein said light source permits illumination of the outlet for at least the minimum period of time required to consume the beverage.

9. The drinking container of claim 1, wherein said light source can be activated by a user using activation means and deactivated by a user using deactivation means.

10. The drinking container of claim 1, wherein said drinking container contains an alcoholic or non-alcoholic beverage.

11. A method of consuming a drink in low light conditions comprising the steps of:
providing a container having at least one outlet;
providing a light source proximate to said outlet wherein said light source is arranged and configured to provide illumination in an area substantially only proximate to said outlet such that a user is made aware of the location of said outlet when consuming a beverage in poor lighting.
